(19) United States
(12) Patent Application Publication
(10) Pub. No.: US 2026/0075526 A1
(43) Pub. Date: Mar. 12, 2026

(54) PDCCH ONLY MONITORING MODE

(71) Applicant: Apple Inc., Cupertino, CA (US)

(72) Inventor: Srinivasan Balasubramanian, San Diego, CA (US)

(21) Appl. No.: 18/827,169

(22) Filed: Sep. 6, 2024

(51) Int. Cl. H04W 52/02; H04W 72/0446; H04W 72/1273; H04W 72/232

(52) U.S. Cl. CPC H04W 52/0235; H04W 52/0216; H04W 72/0446; H04W 72/1273; H04W 72/232

(57) ABSTRACT

Disclosed are methods, systems, and computer-readable medium to perform operations including: receiving, from a network, a trigger activating a Physical Downlink Control Channel (PDCCH) and Physical Downlink Shared Channel (PDSCH) monitoring mode; and responsively monitoring a PDSCH for traffic from the network.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

Power-saving techniques in user equipment (UE) help enhance battery life, minimize energy consumption, and ensure prolonged usability in mobile environments. As modern UEs become increasingly complex, with advanced functionalities and constant connectivity, power demands grow, making efficient energy management crucial. For example, reduced capability (RedCap) UEs, especially benefit from power-saving techniques as they are employed in scenarios where long battery life is critical, such as in Internet-of-Things (IoT) devices or remote sensors.

### SUMMARY

This disclosure describes systems and methods for switching between PDCCH only and PDCCH+PDSCH monitoring modes. One aspect of the subject matter described in this specification may be embodied in a user equipment (UE) that includes one or more processors and memory storing instructions that when executed by the one or more processors, cause the UE to perform operations including: receiving, from a network, a trigger activating in a subsequent slot a Physical Downlink Control Channel (PDCCH) and Physical Downlink Shared Channel (PDSCH) monitoring mode; and responsively monitoring a PDSCH in the subsequent slot for traffic from the network. This aspect may each optionally include one or more of the following features.

In some implementations, activating in the subsequent slot the PDCCH and PDSCH monitoring mode involves transitioning in the subsequent slot from a PDCCH-only monitoring mode to the PDCCH and PDSCH monitoring mode.

In some implementations, the trigger includes a dummy PDSCH grant.

In some implementations, the trigger is downlink control information (DCI).

In some implementations, the trigger is one of a Medium Access Control (MAC) Control Element (CE), a Service Data Adaptation Protocol (SDAP) header, or an IP header.

In some implementations, the operations further include receiving, from the network, a message deactivating the PDCCH and PDSCH monitoring mode.

In some implementations, deactivating the PDCCH and PDSCH monitoring mode involves transitioning from the PDCCH and PDSCH monitoring mode to a PDCCH-only monitoring mode.

In some implementations, the message is downlink control information (DCI).

In some implementations, the message is one of a Medium Access Control (MAC) Control Element (CE), a Service Data Adaptation Protocol (SDAP) header, or an IP header.

In some implementations, the operations further include transmitting to the network UE capability information indicating that the UE supports: (i) the PDCCH and PDSCH monitoring mode, and (ii) a PDCCH-only monitoring mode.

In some implementations, the operations further include transmitting, to the network, a request to switch to the PDCCH and PDSCH monitoring mode.

Another aspect of the subject matter described in this specification may be embodied in one or more processors configured to cause a user equipment to perform operations including: receiving, from a network, a trigger activating a Physical Downlink Control Channel (PDCCH) and Physical Downlink Shared Channel (PDSCH) monitoring mode; and responsively monitoring a PDSCH for traffic from the network. This aspect may each optionally include one or more of the following features.

In some implementations, activating the PDCCH and PDSCH monitoring mode involves transitioning from a PDCCH-only monitoring mode to the PDCCH and PDSCH monitoring mode.

In some implementations, the trigger includes a dummy PDSCH grant.

In some implementations, the trigger is one of a Medium Access Control (MAC) Control Element (CE), a Service Data Adaptation Protocol (SDAP) header, or an IP header.

In some implementations, the operations further include receiving, from the network, a message deactivating the PDCCH and PDSCH monitoring mode.

In some implementations, deactivating the PDCCH and PDSCH monitoring mode involves transitioning from the PDCCH and PDSCH monitoring mode to a PDCCH-only monitoring mode.

In some implementations, the message is one of a Medium Access Control (MAC) Control Element (CE), a Service Data Adaptation Protocol (SDAP) header, or an IP header.

Yet another aspect of the subject matter described in this specification may be embodied in a method that involves receiving, from a network, a trigger activating in a subsequent slot a Physical Downlink Control Channel (PDCCH) and Physical Downlink Shared Channel (PDSCH) monitoring mode; and responsively monitoring a PDSCH in the subsequent slot for traffic from the network. This aspect may each optionally include one or more of the following features.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example cross-slot scheduling scenario.

FIG. 2 illustrates an example wireless network.

FIG. 3A illustrates an example Medium Access Control (MAC) Control Element (CE).

FIG. 3B illustrates an example Service Data Adaptation Protocol (SDAP) header.

FIG. 3C illustrates an example IP header.

FIG. 4A and FIG. 4B each illustrate a flowchart of an example method.

FIG. 5 illustrates an example user equipment (UE).

FIG. 6 illustrates an example access node.

### DETAILED DESCRIPTION

In line with the discussion above, 5G New Radio (NR) has introduced power-saving techniques to reduce user equipment (UE) power consumption. One technique is power-save bandwidth part (BWP). This frequency domain (FD) technique reduces power consumption by dynamically adapting the bandwidth used by a UE. In normal (non-power-save) operations, a UE operates on a carrier bandwidth (CBW) to communicate in a wireless network. The carrier bandwidth can be, for example, 100 Megahertz (MHz). In power-save BWP, however, the UE operates on a sub-band of the overall carrier bandwidth, which enables the UE to reduce power consumption. The sub-band or BWP can be, for example, 20 MHz. Note that power-save BWP is also referred to as FD BWP power saving. The UE can also reduce power consumption by dynamically adapting the bandwidth used by a UE in the time domain (TD). In this technique, called TD BWP power saving, the UE switches between different BWPs in the time domain, perhaps based on traffic demands and power-saving requirements.

Another power-saving technique in 5G NR is Physical Downlink Control Channel (PDCCH)-only monitoring. This power-saving technique enables a UE to monitor only PDCCH—without decoding Physical Downlink Shared Channel (PDSCH)—in a given slot. 3GPP Release 15 Technical Specifications (TSs) introduced cross-slot scheduling as a means for achieving PDCCH-only monitoring. Cross-slot allows for grants provided on PDCCH to be associated with a scheduling of the PDSCH resources to be read in subsequent slots. To save power, the UE enters into sleep or inactive mode between the PDCCH and the PDSCH slots. 3GPP Release 16 TSs further enhanced cross-slot scheduling by introducing UE assistance information (UAI) that specifies a minimum scheduling offset for cross-slot scheduling as a preference from the UE. This offset indicates a minimum gap in terms of the number of symbols between PDCCH and PDSCH slots. With this information, a UE reads only the search space for the PDCCH without having to read the PDSCH when there are not grants for the UE, which can lead to additional power savings. The monitoring of the PDSCH consumes significantly more resources than just monitoring the PDCCH. Note that, in some scenarios, a UE can be configured to implement multiple power-saving techniques to enhance power savings. For example, the UE can be configured to implement both PDCCH-only monitoring and power-save BWP.

Some use cases for PDCCH-only monitoring include when a UE is streaming video content or web browsing. When streaming video content, the UE can store a playout buffer for smooth playback without interruptions. PDCCH-only monitoring allows the UE to wake up and download data only when necessary, such as when the buffer drops below a certain threshold. And when web browsing, the UE data download time (e.g., 5 seconds) is interspaced with data read time (e.g., 45 seconds). PDCCH-only monitoring allows the UE to operate in a low-power mode during the data read time. Other uses cases are possible and are contemplated herein.

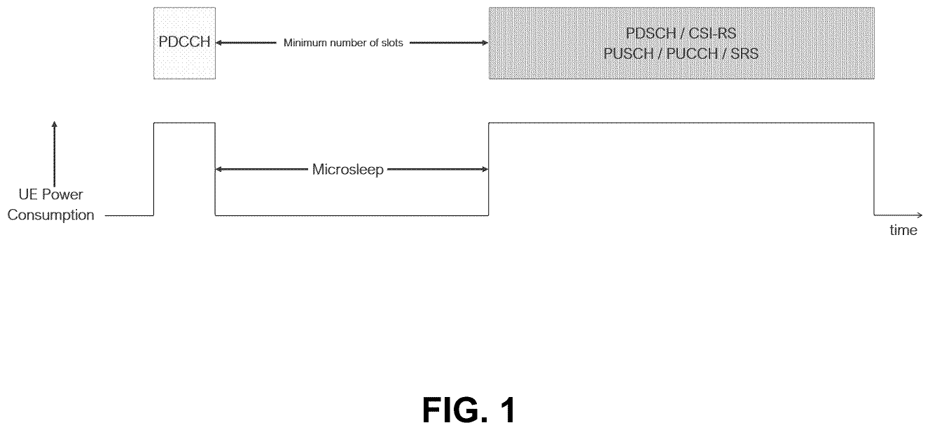

FIG. 1 illustrates an example cross-slot scheduling scenario 100. As shown in FIG. 1, at a first monitoring instance, a UE (not illustrated) wakes up to monitor PDCCH. The UE then enters microsleep until a second monitoring instance for monitoring PDSCH (or to communicate on other channels). As shown in FIG. 1, cross-slot scheduling reduces UE power consumption by: (1) allowing the UE to monitor PDCCH only in the first monitoring instance, and (2) allowing the UE to enter a microsleep state until the next monitoring instance.

Cross-slot scheduling, however, has limitations in power-save BWP. Cross-slot scheduling can impact scheduler realizations to maintain fairness across users/flows. Additionally, cross-slot scheduling can impact data transfer rates, and therefore, can affect devices that have specified data transfer requirements. For example, a device manufacturer or a mobile network operator may have a requirement of maintaining a threshold data transfer rate, e.g., 1 Megabits per second (Mbps), while operating in power-save BWP. Cross-slot scheduling, however, may prevent a device from maintaining the required data transfer rate.

This disclosure describes systems and methods for switching between PDCCH only and PDCCH+PDSCH monitoring modes. Among other benefits, the disclosed systems and methods enable devices to reap the power-saving benefits of PDCCH-only monitoring while minimizing the effect on device performance (e.g., scheduler realizations, data transfer rate, etc.).

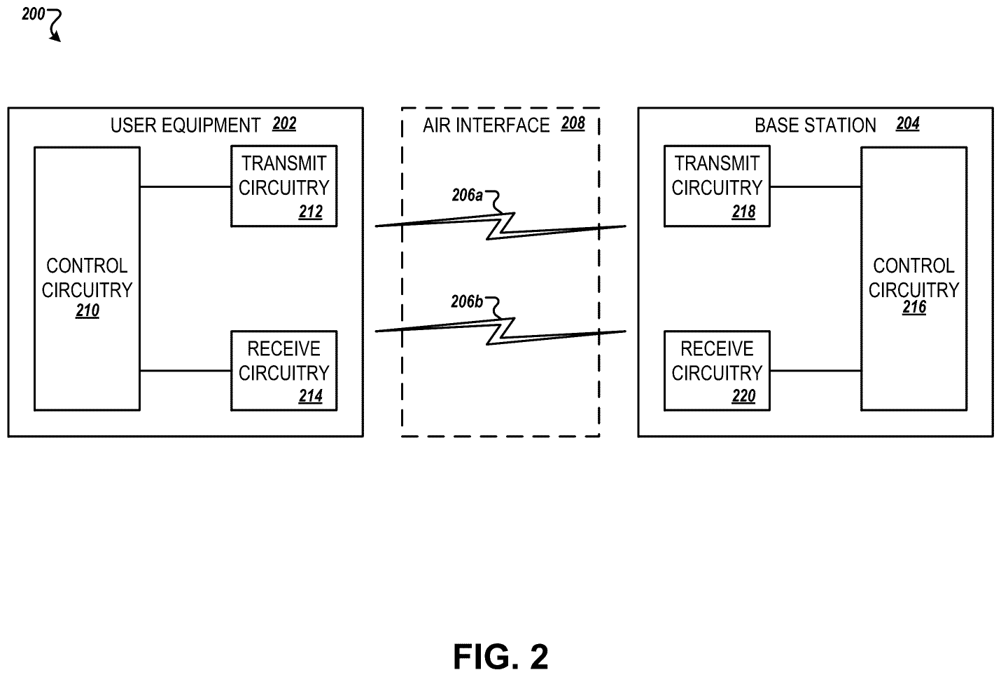

FIG. 2 illustrates a wireless network 200. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

In some implementations, the wireless network 200 is a Standalone (SA) network, e.g., that incorporates 5G NR. In some other implementations, the wireless network 200 is a Non-Standalone (NSA) network that incorporates Long Term Evolution (LTE) and 5G NR. In these implementations, the wireless network 200 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 200, the UE 202 and any other UE in the system may be, for example, any of a laptop computer, smartphone, tablet computer, machine-type device (such as smart meters or specialized devices for healthcare), intelligent transportation system, or any other wireless device. In network 200, the base station 204 provides the UE 202 network connectivity to a broader network (not shown). This UE 202 connectivity is provided via the air interface 208 in a base station service area provided by the base station 204. In some implementations, such a broader network may be a wide area network operated by a cellular network provider, or may be the Internet. Each base station service area associated with the base station 204 is supported by one or more antennas integrated with the base station 204. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may include application-specific circuitry, baseband circuitry, or any of various combinations thereof. The transmit circuitry 212 and receive circuitry 214 may be adapted to transmit and receive data, respectively, and may include radio frequency (RF) circuitry and/or front-end module (FEM) circuitry.

In various implementations, aspects of the transmit circuitry 212, receive circuitry 214, and/or control circuitry 210 may be integrated in various ways to implement the operations described herein. The control circuitry 210 may be adapted or configured to perform various operations, such as those described elsewhere in this disclosure related to a UE. Additionally, the transmit circuitry 212 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 212 may be configured to receive block data from the control circuitry 210 for transmission on the air interface 208.

Additionally, the receive circuitry 214 may receive a plurality of multiplexed downlink physical channels from the air interface 208 and relay the physical channels to the control circuitry 210. The plurality of downlink physical channels may be multiplexed, e.g., according to TDM or FDM, e.g., along with carrier aggregation. The transmit circuitry 212 and the receive circuitry 214 may transmit and receive, respectively, both control data and content data (e.g., messages, images, video, etc.) structured within data blocks that are carried by the physical channels.

FIG. 2 also illustrates the base station 204. In some implementations, the base station 204 may be a 5G radio access network (RAN), a next generation RAN, a E-UTRAN, a non-terrestrial cell, or a legacy RAN, such as a UTRAN. As used herein, the term “5G RAN” or the like may refer to the base station 204 that operates in an NR wireless network 200, and the term “E-UTRAN” or the like may refer to a base station 204 that operates in an LTE wireless network 200. The UE 202 utilizes connections (or channels) 206A, 206B, each of which includes a physical communications interface or layer.

The base station 204 circuitry may include control circuitry 216 coupled (directly or indirectly) with transmit circuitry 218 and/or receive circuitry 220. The transmit circuitry 218 and receive circuitry 220 may each be coupled (directly or indirectly) with one or more antennas that may be used to enable communications via the air interface 208. The transmit circuitry 218 and receive circuitry 220 may be adapted to transmit and receive data, respectively, addressed to any UE connected to the base station 204. The receive circuitry 220 may receive a plurality of uplink physical channels from one or more UEs, including the UE 202.

In FIG. 2, the one or more channels 206A, 206B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 202 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

In some implementations, a core network (“network”), e.g., via the base station 204, can configure the UE 202 to use one or more bandwidth parts (BWPs). A BWP can be a subset of the total available bandwidth for the wireless network 200, which enables the network to allocate a specified portion of bandwidth to the UE 202. The network can configure the UE 202 with more than one BWP and can instruct the UE 202 to dynamically switch between the different BWPs. In one example, the network uses downlink control information (DCI) to instruct the UE 202 to switch between BWPs.

In line with the discussion above, this disclosure describes systems and methods for dynamically switching between PDCCH-only and PDCCH+PDSCH monitoring modes, for example, for power-saving goals.

In some implementations, the UE 202 is configured with two BWPs: a power-save BWP that supports power-save operations (e.g., cross-slot scheduling) and a BWP that supports normal (non-power-save) operations, e.g., the CBW. In these implementations, the UE 202 is configured to switch from the power-save BWP to the CBW to support data traffic, perhaps traffic of at least a threshold size, e.g., 16 bytes. Accordingly, the UE 202 is configured to operate in PDCCH-only monitoring mode when in the power-save BWP and in PDCCH+PDSCH monitoring mode when in the CBW. In some examples, the BWP switching is performed using DCI-based control. In these examples, the network uses DCI commands to instruct the UE 202 to switch between the power-save BWP (with cross-slot scheduling) and the CBW (with normal scheduling). This allows the UE 202 to use cross-slot scheduling for PDCCH-only monitoring in the power-save BWP and normal scheduling in the CBW, e.g., for traffic over a threshold size.

In some implementations, the UE 202 is configured to use two power-save BWPs: a first power-save BWP with cross-slot scheduling and a second power-save BWP with normal scheduling. In these implementations, the UE 202 is configured to switch from the first power-save BWP to the second power-save BWP to support data traffic, perhaps traffic of at least a threshold size, e.g., 16 bytes. In some examples, switching between the two power-save BWPs is performed using Radio Resource Control (RRC) signaling. In these examples, the network sends the UE 202 RRC signaling that instructs the UE to switch between the BWPs. In other examples, switching between the two power-save BWPs is performed using DCI (existing or new DCI). In these examples, the network sends the UE 202 DCI that instructs the UE to switch between the BWPs. Note that the two power-save BWPs can be in addition to the CBW, so, in these implementations, the UE 202 can be configured with three BWPs.

In some implementations, the UE 202 is configured to monitor PDCCH only (while either in the power-save BWP or the CBW). In a first alternative, the UE 202 is configured to activate PDSCH monitoring in response to receiving a scheduling grant. Note that, here, because the UE 202 activates PDSCH monitoring after receiving the scheduling grant, the UE 202 misses an initial transmission, e.g., a first hybrid automatic repeat request (HARQ) transmission (RV 0), associated with that scheduling grant (e.g., received in the same slot as the scheduling grant). The UE 202, however, retains PDSCH monitoring for subsequent transmissions and can recover the data lost in the initial transmission. Then, in response to detecting no UE scheduling activity for a threshold period, e.g., 50 milliseconds (ms), the UE 202 is configured to revert to monitoring PDCCH-only.

In a second alternative, the UE 202 is configured to activate PDSCH monitoring in a subsequent slot in response to receiving a trigger from the network. In some examples, the trigger is a dummy PDSCH scheduling grant (e.g., a data-free scheduling grant). Then, the network schedules PDSCH traffic after the slot in which the UE 202 receives the “PDSCH monitoring activation” trigger. Because the network starts scheduling PDSCH traffic in the same slot in which the UE 202 starts to monitor PDSCH, the UE does not miss any PDSCH transmissions. Once the downlink traffic burst is complete, the network sends a “PDSCH monitoring deactivation” message to the UE 202. In response to receiving the deactivation message, the UE 202 reverts to monitoring PDCCH only. The UE 202, therefore, switches between PDCCH-only and PDCCH+PDSCH monitoring modes. Note that this feature is different from the existing wakeup signaling (WUS) feature, which is tied to Connected Mode Discontinuous Reception (C-DRX) and also does not support both activation and deactivation.

Note that because Reduced Capability (RedCap) devices are camping on the power-save BWP for regular operations, to manage capacity, regular devices (non-RedCap devices) can be moved to the CBW for actual traffic exchange. RedCap UEs are limited to 20 MHz from an RF capability and tend to stay on the 20 MHz overlapping with the resources where the base station supports the CD-SSB (Cell-Defining SSBs). This makes this 20 MHz part of the cell bandwidth congested. Accordingly, UEs that are capable of wider bandwidths can be switched to operating on the full carrier bandwidth for this component carrier.

In some implementations, to transition from PDCCH+PDSCH monitoring mode to PDCCH-only monitoring mode, a DCI “1_4 Switch to PDCCH-only monitoring mode” is used. In response to receiving this command from the network, the UE 202 moves to monitoring PDCCH-only starting from the subsequent slot (e.g., the slot after the slot in which the DCI is received). In some implementations, to transition from PDCCH-only monitoring mode to PDCCH+PDSCH monitoring mode, a DCI “1_5 Switch to PDCCH+PDSCH monitoring mode” is used. In response to receiving this command from the network, the UE 202 moves to monitoring PDCCH+PDSCH starting from the subsequent slot (e.g., the slot after the slot in which the DCI is received). In some examples, if the UE 202 misses this command, and subsequently receives a PDSCH scheduling grant, the UE is configured to automatically switch to PDCCH+PDSCH monitoring mode in the subsequent slot.

In some implementations, the UE 202 is configured to use UE capability information to inform the network that the UE supports switching between PDCCH-only monitoring mode and PDCCH+PDSCH monitoring mode. In some implementations, the UE 202 is configured to indicate in real-time through UE assistance information to the network to control operating between the two modes. Additionally and/or alternatively, the UE 202 can use uplink control information (UCI) to directly request from the network to switch to PDCCH-only mode or PDCCH+PDSCH monitoring mode.

In some implementations, the network does not use DCI to instruct the UE 202 switch between PDCCH only and PDCCH+PDSCH monitoring modes. In these implementations, the network uses a Medium Access Control (MAC) Control Element (CE) to indicate to the UE 202 to switch to PDCCH only monitoring. In some examples, the MAC CE is sent with a last scheduled packet on the downlink, e.g., from the RAN scheduler. And to instruct the UE 202 to switch to PDCCH+PDSCH monitoring, the network can start scheduling grants to the UE. The UE 202 switches to PDCCH+PDSCH monitoring mode in response to receiving a scheduling grant. In some examples, the network can introduce a dummy packet into the scheduler path to avoid the UE 202 missing the first HARQ transmission of the first packet scheduled to it while in PDCCH only monitoring mode. The dummy packet may be a MAC CE with a specified field set to a particular value to instruct the UE 202 to switch to PDCCH+PDSCH monitoring mode. For instance, a value of ‘0’ instructs the UE 202 to switch to PDCCH only monitoring mode and a value of ‘1’ instructs the UE 202 to switch to PDCCH+PDSCH monitoring mode.

In some implementations, to support this feature, 3GPP TS 38.321 can be modified to include the following feature:

### Switch to PDCCH Only Monitoring

The network may switch the UE to monitoring of PDCCH only by sending the PDCCH Only Monitoring indication MAC CE described in clause shown.

The MAC entity shall:
1> If the MAC Entity Receives a PDCCH Only Monitoring Indication MAC CE:
2> indicate to lower layers the information regarding PDCCH Only Monitoring Indication MAC CE.

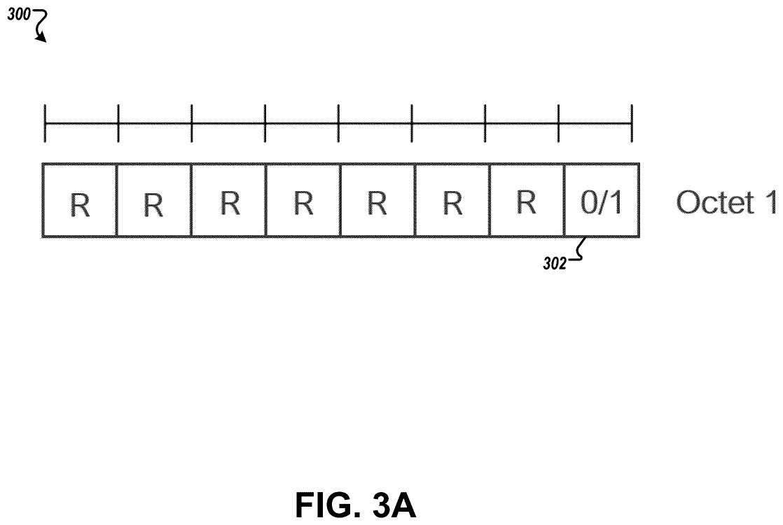

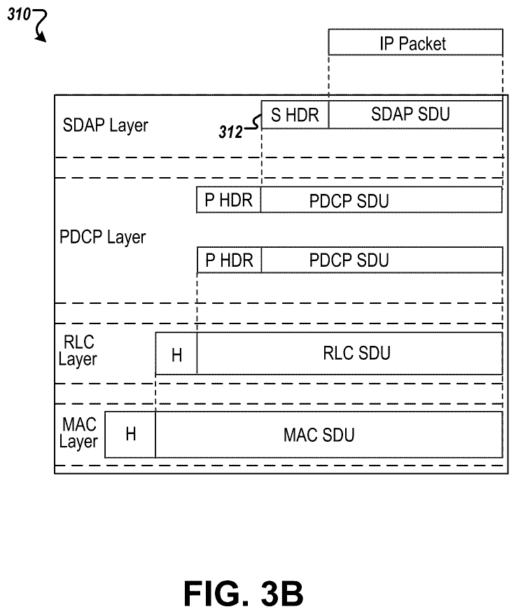

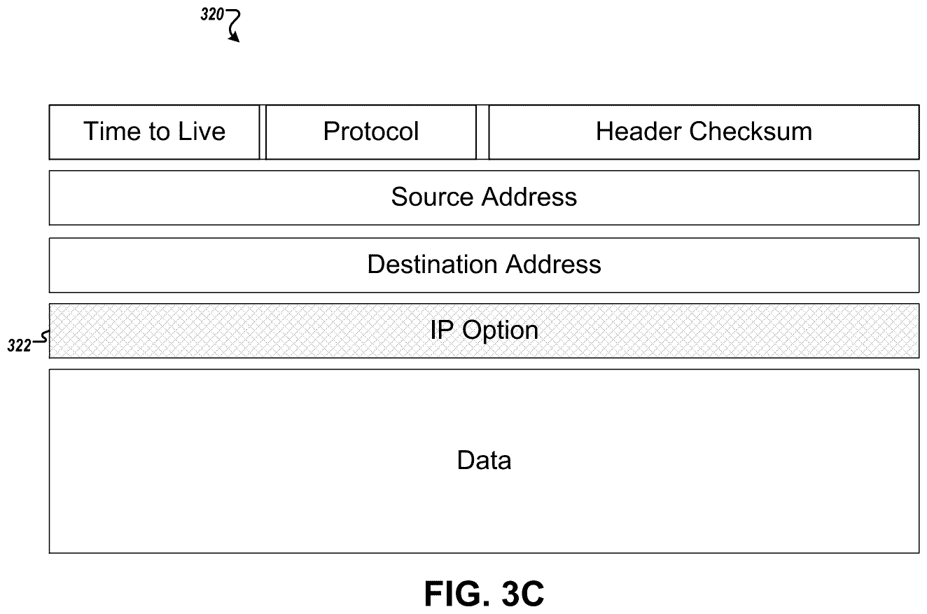

FIG. 3A illustrates an example MAC CE 300. As shown in FIG. 3A, the MAC CE 300 includes a 1-bit field 302 that can be set to ‘0’ or ‘1.’ In one example, a value of ‘0’ instructs the UE 202 to switch to PDCCH only monitoring mode and a value of ‘1’ instructs the UE 202 to switch to PDCCH+PDSCH monitoring mode.

In some implementations, the network does not use DCI or MAC CE to switch between PDCCH only and PDCCH+PDSCH monitoring modes. In a first alternative, a Service Data Adaptation Protocol (SDAP) header is used to instruct the UE 202 to switch between PDCCH only and PDCCH+PDSCH monitoring modes. Specifically, the SDAP header is modified to include an additional parameter that instructs the UE 202 to switch to PDCCH-only monitoring mode. In some examples, this parameter can be set only on the last downlink packet sent to the UE 202. Additionally, regular scheduling is used to instruct the UE 202 to return to PDCCH+PDSCH monitoring mode. Note that the UE 202 may miss the first HARQ transmission of the first packet sent to the UE while in PDCCH only monitoring mode.

FIG. 3B illustrates an example packet 310. As shown in FIG. 3B, the packet 310 includes an SDAP header 312. In some examples, the SDAP header 312 is modified to include an additional parameter that instructs the UE 202 to switch to PDCCH-only monitoring mode. The parameter can be set only on the last downlink packet sent to the UE 202.

In a second alternative, an ‘IP option’ field in an IP header is used to instruct the UE 202 to switch between PDCCH only and PDCCH+PDSCH monitoring modes. In this alternative, a specific signature is created to support indicating the UE to switch to PDCCH only monitoring mode. In some examples, this signature is used only on the last downlink packet for the UE 202 and when the downlink buffers to the UE are empty. Additionally, regular scheduling is used to return to PDCCH+PDSCH monitoring mode. Note that the UE 202 may miss the first HARQ transmission of the first packet sent to the UE while in PDCCH only monitoring mode.

FIG. 3C illustrates an example IP header 320. As shown in FIG. 3C, the IP header 320 includes an IP option field 322. In some examples, the IP option field 322 includes a specific signature that instructs the UE 202 to switch to PDCCH-only monitoring mode. The parameter can be set only on the last downlink packet sent to the UE 202.

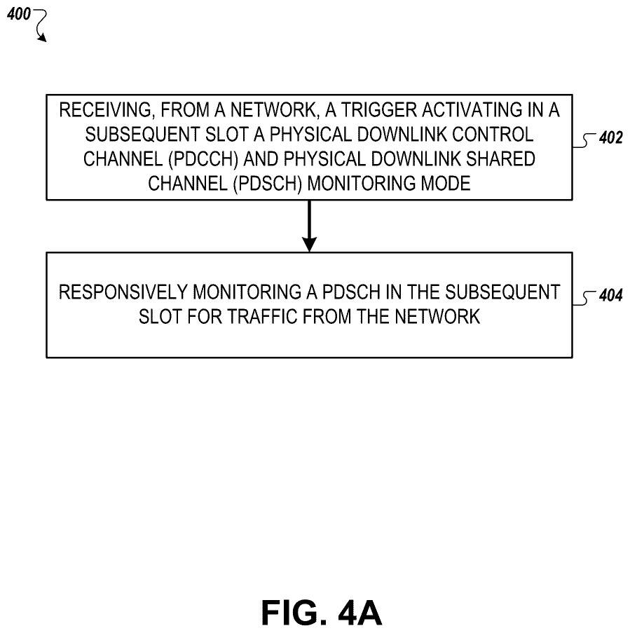

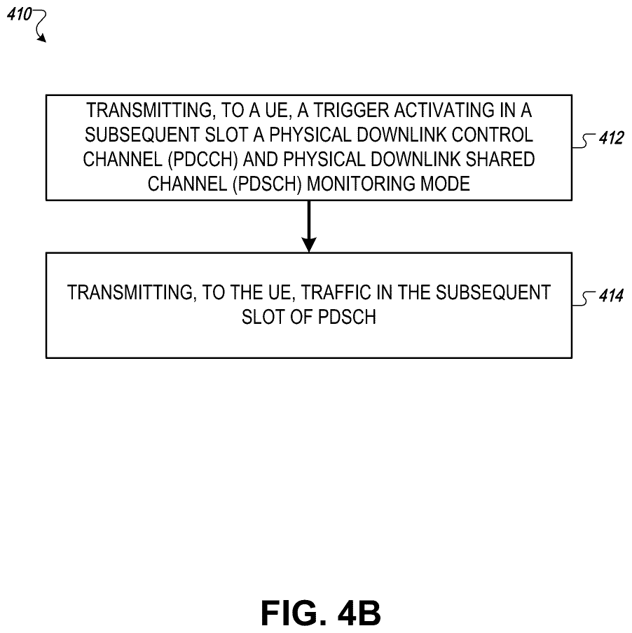

FIG. 4A illustrates a flowchart of an example method 400, according to some implementations. For clarity of presentation, the description that follows generally describes method 400 in the context of the other figures in this description. For example, method 400 can be performed by UE 202 of FIG. 2. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At step 402, method 400 involves receiving, from a network, a trigger activating in a subsequent slot a Physical Downlink Control Channel (PDCCH) and Physical Downlink Shared Channel (PDSCH) monitoring mode.

At step 404, method 400 involves responsively monitoring a PDSCH in the subsequent slot for traffic from the network.

In some implementations, activating in the subsequent slot the PDCCH and PDSCH monitoring mode involves transitioning in the subsequent slot from a PDCCH-only monitoring mode to the PDCCH and PDSCH monitoring mode.

In some implementations, the trigger includes a dummy PDSCH grant.

In some implementations, the trigger is downlink control information (DCI).

In some implementations, the trigger is one of a Medium Access Control (MAC) Control Element (CE), a Service Data Adaptation Protocol (SDAP) header, or an IP header.

In some implementations, the method further involves receiving, from the network, a message deactivating the PDCCH and PDSCH monitoring mode.

In some implementations, deactivating the PDCCH and PDSCH monitoring mode involves transitioning from the PDCCH and PDSCH monitoring mode to a PDCCH-only monitoring mode.

In some implementations, the message is downlink control information (DCI).

In some implementations, the method further involves transmitting to the network UE capability information indicating that the UE supports: (i) the PDCCH and PDSCH monitoring mode, and (ii) a PDCCH-only monitoring mode.

In some implementations, the method further involves transmitting to the network a request to switch to the PDCCH and PDSCH monitoring mode.

FIG. 4B illustrates a flowchart of an example method 410, according to some implementations. For clarity of presentation, the description that follows generally describes method 410 in the context of the other figures in this description. For example, method 410 can be performed by base station 204 of FIG. 2. It will be understood that method 410 can be performed, for example, by any suitable system, environment, software, hardware, or a combination of systems, environments, software, and hardware, as appropriate. In some implementations, various steps of method 410 can be run in parallel, in combination, in loops, or in any order.

At step 412, method 410 involves transmitting, to a UE, a trigger activating in a subsequent slot a Physical Downlink Control Channel (PDCCH) and Physical Downlink Shared Channel (PDSCH) monitoring mode.

At step 414, method 410 involves transmitting, to the UE, traffic in the subsequent slot of PDSCH.

In some implementations, the trigger is a dummy PDSCH grant.

In some implementations, the trigger of a dummy PDSCH grant is a MAC CE transmitted to activate the UE to monitor both the PDCCH and PDSCH.

In some implementations, the trigger is downlink control information (DCI).

In some implementations, the trigger is one of a Medium Access Control (MAC) Control Element (CE), a Service Data Adaptation Protocol (SDAP) header, or an IP header.

In some implementations, the method further involves transmitting, to the UE, a message deactivating the PDCCH and PDSCH monitoring mode.

In some implementations, the message is downlink control information (DCI).

In some implementations, the message is one of a Medium Access Control (MAC) Control Element (CE), a Service Data Adaptation Protocol (SDAP) header, or an IP header.

In some implementations, the method further involves receiving, from the UE, UE capability information indicating that the UE supports: (i) the PDCCH and PDSCH monitoring mode, and (ii) a PDCCH-only monitoring mode.

In some implementations, the method further involves receiving, from the UE, a request to switch to the PDCCH and PDSCH monitoring mode.

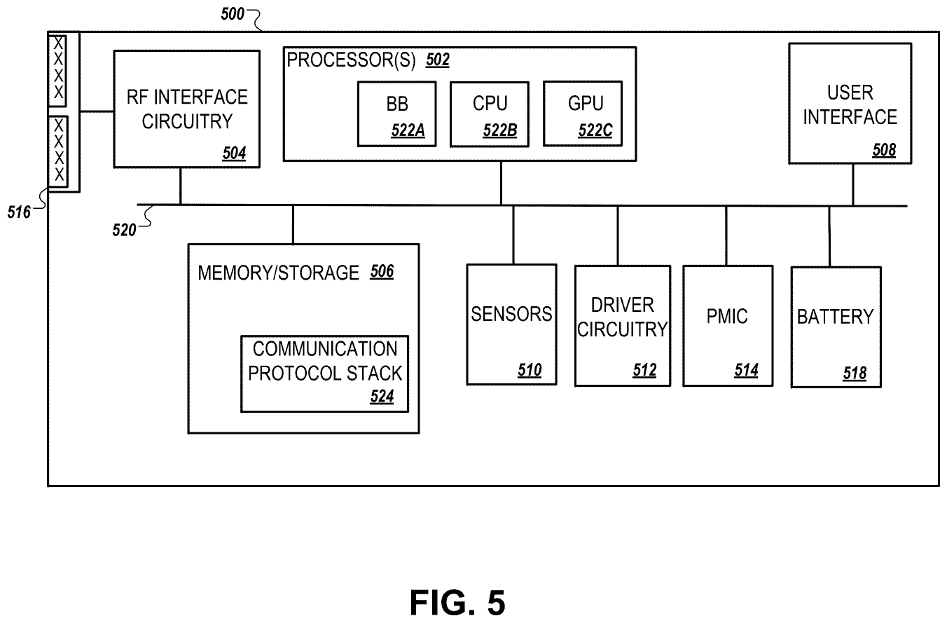

FIG. 5 illustrates an example UE 500. The UE 500 may be similar to and substantially interchangeable with UE 202 of FIG. 2.

The UE 500 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 500 may include any/all of processor 502, RF interface circuitry 504, memory/storage 506, user interface 508, sensors 510, driver circuitry 512, power management integrated circuit (PMIC) 514, one or more antenna(s) 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and a different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc., that allows various circuit components (on common or different chips or chipsets) to interact with one another.

The processor 502 may include one or more processors. For example, the processor 502 may include processor circuitry such as, for example, baseband processor circuitry (BB) 522A, central processor unit circuitry (CPU) 522B, and graphics processor unit circuitry (GPU) 522C. The processor 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM”in the uplink.

The memory/storage 506 may include one or more non-transitory, computer-readable media that includes instructions (for example, communication protocol stack 524) that may be executed by the processor 502 to cause the UE 500 to perform various operations described herein. The memory/storage 506 include any type of volatile or non-volatile memory that may be distributed throughout the UE 500. In some implementations, some of the memory/storage 506 may be located on the processor 502 itself (for example, L1 and L2 cache), while other memory/storage 506 is external to the processor 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 516 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 516. In various implementations, the RF interface circuitry 504 may be configured to transmit/receive signals in a manner compatible with NR access technologies.

The antenna(s) 516 may include one or more antenna elements to convert electrical signals into radio waves to travel through the air and to convert received radio waves over the air into electrical signals. In some implementations, the antenna elements may be arranged into one or more antenna panels. The antenna(s) 516 may have antenna panels that are omnidirectional, directional, or a combination thereof, to enable beamforming and multiple input, multiple output communications. The antenna(s) 516 may include any/all of microstrip antennas, printed antennas fabricated on the surface of one or more printed circuit boards, patch antennas, phased array antennas, etc. The antenna(s) 516 may have one or more panels designed for one or more specific frequency bands, such as bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processor 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

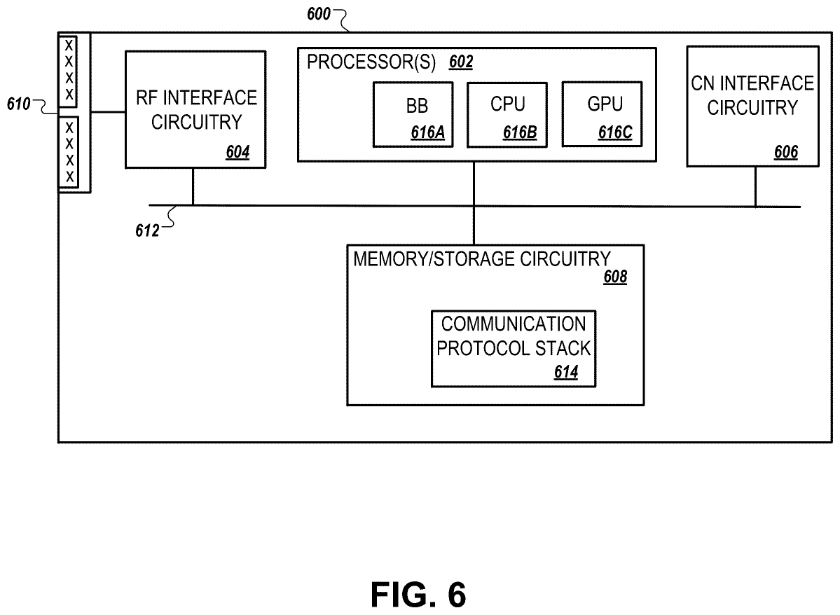

FIG. 6 illustrates an example access node 600 (e.g., a base station or gNB), according to some implementations. The access node 600 may be similar to and substantially interchangeable with base station 204. The access node 600 may include one or more of processor 602, RF interface circuitry 604, core network (CN) interface circuitry 606, memory/storage circuitry 608, and one or more antenna(s) 610. The processor 602 may include any type of circuitry or processor circuitry that executes or otherwise operates computer-executable instructions, such as program code, software modules, or functional processes from memory/storage circuitry 608 to cause the access node 600 to perform operations as described herein.

The components of the access node 600 may be coupled with various other components over one or more interconnects 612. The processor 602, RF interface circuitry 604, memory/storage circuitry 608 (including communication protocol stack 614), antenna(s) 610, and interconnects 612 may be similar to like-named elements shown and described with respect to FIG. 4. For example, the processor 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

The 5GC network is implemented on one or more computing systems and can include several Network Functions (NFs) that work together to deliver the capabilities of 5G. The 5GC network includes an Access and Mobility Management Function (AMF), which manages user registration, connection, and mobility. The 5GC network also includes a Session Management Function (SMF) that oversees session establishment and IP address allocation. Additionally, the 5GC network includes a Network Slice Selection Function (NSSF) that enables the 5GC to support network slicing, allowing the creation of virtual networks. A Policy Control Function (PCF) of the 5GC enforces quality of service (QoS) and access policies, ensuring that network resources are allocated according to predefined rules.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit. ” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,”and the like.

Various components may be described as performing a task or tasks, for convenience in the description. Such descriptions should be interpreted as including the phrase “configured to. ” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A user equipment (UE) comprising:
one or more processors; and
memory storing instructions that when executed by the one or more processors, cause the UE to perform operations comprising:
receiving, from a network, a trigger activating, in a subsequent slot, a Physical Downlink Control Channel (PDCCH) and Physical Downlink Shared Channel (PDSCH) monitoring mode; and
responsively monitoring a PDSCH in the subsequent slot for traffic from the network.

2. The UE of claim 1, wherein activating in the subsequent slot the PDCCH and PDSCH monitoring mode comprises:
transitioning in the subsequent slot from a PDCCH-only monitoring mode to the PDCCH and PDSCH monitoring mode.

3. The UE of claim 1, wherein the trigger comprises a dummy PDSCH grant.

4. The UE of claim 1, wherein the trigger is downlink control information (DCI).

5. The UE of claim 1, wherein the trigger is one of a Medium Access Control (MAC) Control Element (CE), a Service Data Adaptation Protocol (SDAP) header, or an IP header.

6. The UE of claim 1, the operations further comprising:
receiving, from the network, a message deactivating the PDCCH and PDSCH monitoring mode.

7. The UE of claim 6, wherein deactivating the PDCCH and PDSCH monitoring mode comprises:
transitioning from the PDCCH and PDSCH monitoring mode to a PDCCH-only monitoring mode.

8. The UE of claim 6, wherein the message is downlink control information (DCI).

9. The UE of claim 6, wherein the message is one of a Medium Access Control (MAC) Control Element (CE), a Service Data Adaptation Protocol (SDAP) header, or an IP header.

10. The UE of claim 1, the operations further comprising:
transmitting to the network UE capability information indicating that the UE supports: (i) the PDCCH and PDSCH monitoring mode, and (ii) a PDCCH-only monitoring mode.

11. The UE of claim 1, the operations further comprising:
transmitting, to the network, a request to switch to the PDCCH and PDSCH monitoring mode.

12. One or more processors configured to cause a user equipment to perform operations comprising:
receiving, from a network, a trigger activating a Physical Downlink Control Channel (PDCCH) and Physical Downlink Shared Channel (PDSCH) monitoring mode; and
responsively monitoring a PDSCH for traffic from the network.

13. The one or more processors of claim 12, wherein activating the PDCCH and PDSCH monitoring mode comprises:
transitioning from a PDCCH-only monitoring mode to the PDCCH and PDSCH monitoring mode.

14. The one or more processors of claim 12, wherein the trigger comprises a dummy PDSCH grant.

15. The one or more processors of claim 12, wherein the trigger is one of a Medium Access Control (MAC) Control Element (CE), a Service Data Adaptation Protocol (SDAP) header, or an IP header.

16. The one or more processors of claim 12, the operations further comprising:
receiving, from the network, a message deactivating the PDCCH and PDSCH monitoring mode.

17. The one or more processors of claim 16, wherein deactivating the PDCCH and PDSCH monitoring mode comprises:
transitioning from the PDCCH and PDSCH monitoring mode to a PDCCH-only monitoring mode.

18. The one or more processors of claim 16, wherein the message is one of a Medium Access Control (MAC) Control Element (CE), a Service Data Adaptation Protocol (SDAP) header, or an IP header.

19. A method comprising:
receiving, from a network, a trigger activating, in a subsequent slot, a Physical Downlink Control Channel (PDCCH) and Physical Downlink Shared Channel (PDSCH) monitoring mode; and
responsively monitoring a PDSCH in the subsequent slot for traffic from the network.

20. The method of claim 19, wherein activating in the subsequent slot the PDCCH and Physical PDSCH monitoring mode comprises:
transitioning in the subsequent slot from a PDCCH-only monitoring mode to the PDCCH and PDSCH monitoring mode.
